(19) United States
(12) Patent Application Publication
(10) Pub. No.: US 2004/0005398 A1
(43) Pub. Date: Jan. 8, 2004

(54) Coffee processing method and coffee product

(75) Inventors: Thomas J. Slaga, Golden, CO (US); Jifu Zhao, Littleton, CO (US)

Correspondence Address: David G. Henry, P.O. Box 1470, 900 Washington Avenue, Waco, TX, 76703-1470, US

(73) Assignee: Applied Food Sciences, Austin, TX

(21) Appl. No.: 10/387,339

(22) Filed: Mar. 12, 2003

Related U.S. Application Data
(63) Continuation of application No. 09/717,890, filed on Nov. 20, 2000, now abandoned.

(51) Int. Cl. A23F 5/00

(52) U.S. Cl. 426/595

(57) ABSTRACT

A coffee processing method and ground coffee end product which depends upon the blending of portions of coffee beans which are variously roasted (green, slightly roasted, medium roast and dark roast). The method produces a coffee end product which is more flavorful (through a reduced loss of natural aromas from green, light, medium and dark roasted beans), more antioxidants (phenolic compounds), more diterpenes (having detoxification properties) and less DNA-damaging compounds which are generated during roasting of coffee, especially dark-roasted coffee. The new coffee keeps the smell and taste of conventional dark-roasted coffee and as well have fresh taste and smell from green and light-roasted beans.

### CITATION TO PRIOR APPLICATION

This is a continuation application with respect to U.S. co-pending application, Ser. No. 09/717,890, from which priority is claimed.

### BACKGROUND OF THE INVENTION

1. Field of the Invention

The present invention relates to beverages and method for processing beverage substrates, coffee in particular.

2. Background Information

This invention relates to new coffee beans with an increased phenolic acid and aroma contents, as well as to produce powder-form and instant coffee using the new beans.

Phenolic acids in coffee are mainly esters of quinic acid with different amount of caffeyl groups attached to its different positions. The phenolic acids present in coffee such as chlorogenic acid, caffeic acid, para-coumaric acid and eugenol have been shown to exert cancer preventive activities in animal models. Chlorogenic acid has also been found to inhibit methylazoxymethanol-induced large intestinal tumors in hamster.

Furthermore, it has now been found that coffee with a higher content of phenolic acids can be more easily digested. Chlorogenic acid, which is the main phenolic acid in coffee, is able to protect the gastric mucosa against irritations, and, therefore, improves the digestibility of foods, beverages and medicaments. The improved digestibility is expressed through a much reduced systemic acid secretion (such as causes heartburn, etc.) which has been found to be directly dependent on an increased level of chlorogenic acid content in roasted coffee.

It is clear, then, that a coffee processing methodology which yields an end product which is higher in phenolic acids (less is removed by the roasting process), but which lacks detrimental flavor alterations, would be a highly desirable contribution. Normally the natural chlorogenic acid content of coffee is reduced by approximately 40 to 80% during conventional roasting process. Analysis by the present inventor indicates that green coffee beans which initially contain 4% phenolic acids contain, respectively, 2% phenolic acids when light roasted, 1% when medium roasted, and less than 0.5% when dark roasted. This clearly represents a significant loss of beneficial compounds.

In addition to reducing beneficial chlorogenic acid constituent, conventional coffee roasting processes also produce a loss of overall weight (or the order of 12% to 17% of the initial raw coffee bean weight). The weight loss is due to the loss of residual moisture content still present in the raw coffee after drying, and through the loss by evaporation or chemical composition, of various constituents of the raw coffee, including the phenolic acids. Weight represents money to processed coffee vendors, so, in addition to inherently providing a more beneficial product which happens to be heavier because of a higher residual content of phenolic acids, producing a heavier processed coffee per unit green coffee bean input is simply an economic benefit to the vendor.

To continue the litany of problems with conventional coffee roasting processes: roasting also destroys natural aroma of green coffee beans, and generates bad compounds, such as 4-aminobiphenyl (ABP), 2-amino-1-methyl-6-phenyllimidazo[4,5-b]pyridine (PhIP) and glyoxal.

### SUMMARY OF THE INVENTION

In view of the foregoing, it is an object of the present invention to provide an improved coffee processing method.

It is another object of the present invention to provide an improved coffee product.

It is another object of the present invention to provide an improved raw coffee processing method which yields a more healthful end product.

It is another object of the present invention to provide an improved raw coffee processing method which yields processed coffee beans or powdered coffee which is higher in weight per unit green bean input than product processed by conventional methods.

It is another object of the present invention to provide an improved raw coffee processing method which yields an end product which is higher in phenolic acid content per than coffee product which is processed by conventional methods.

It is another object of the present invention to provide an improved raw coffee processing method which yields a more easily digestible end product.

It is another object of the present invention to provide an improved raw coffee processing method which yields a more healthful end product, without any undesirable taste alterations.

In satisfaction of these and related objects, the present invention provides a novel and unobvious coffee processing method and ground coffee end product which depends upon the blending of portions of coffee beans which are variously roasted (green, slightly roasted, medium roast and dark roast). Remarkably, this simple method of the present invention produces a coffee end product which is more flavorful (through a reduced loss of natural aromas from green, light, medium and dark roasted beans), more antioxidants (phenolic compounds), more diterpenes (having detoxification properties) and less DNA-damaging compounds which are generated during roasting of coffee, especially dark-roasted coffee. The new coffee keeps the smell and taste of conventional dark-roasted coffee and as well have fresh taste and smell from green and light-roasted beans.

### DETAILED DESCRIPTION OF THE PREFERRED EMBODIMENT

The new powder-form coffee)of the preferred mode of the present invention is the product of blending portions of variously roasted coffee beans. This is a significant departure from conventional coffee processes methods, where all of the beans which contribute to an end product are roasted to substantially the same degree as the desired end product degree of roast dictates, whereas the end product of the present invention achieves the perceived degree of roast through what might loosely be called an “averaging” of the roast of the plural portions of a blended coffee bean product. Surprisingly, brewed coffee made from the blended coffee powders of the present invention are perceived by consumers as being substantially of the degree of roast of the darkest roast constituent. Thus, a blend containing a relatively high proportion of slightly roasted beans still gives a product which from the sensory standpoint corresponds to a coffee with the higher degree of roasting of the other portions (if the latter portions of more darkly roasted beans is more than negligible—say more than 10% by weight). On the other hand, substantial health benefits and increased tolerability of brewed coffee will arise from a constituence of more than a negligible amount of the beans of a lesser degree of roast than that desired to be perceived by consumers.

To the consumer, there is little change in the perceived taste of the product, yet that which is consumed is substantially more healthful and easily tolerated.

Variations in the blending of multiply roasted coffee beans will arise from differing desired end results. Following are examples of blends made under the present invention, each using Brazilian green coffee beans which were determined to contain 4.4% of phenolic acids by UV photometric method and 2.8% of chlorogenic acid.

### EXAMPLE 1

A blend of coffee beans is prepared according to the following constituency: one fourth by weight of green beans (no roasting), one fourth of beans being slightly roasted, one fourth being roasted to “medium dark”, and the last one fourth is roasted to a “dark roast.” The four portions are mixed together and ground to get new coffee I.

Chemical analysis showed that the new coffee I contains 2.9% of phenolic acids and 1.5% of chlorogenic acid; whereas dark-roasted beans alone only contain 0.9% of phenolic acids and 0.6% of chlorogenic acid. Because PhIP, glyoxal and so on are only present in roasted, especially dark-roasted beans, the new coffee I contains much lower levels of those harmful compounds.

### EXAMPLE 2

A blend of coffee beans is prepared according to the following constituency: one third by weight of beans being slightly roasted, one third being roasted to “medium dark”, and the last third is roasted to a “dark roast.” The three portions are mixed together and ground to get new coffee II.

Chemical analysis showed that the new coffee II contains 2.2% of phenolic acids and 1.2% of chlorogenic acid, and contains significantly lower levels of of PhIP, glyoxal and other harmful compounds than like weight of conventionally roasted coffee powders.

### EXAMPLE 3

A blend of coffee beans is prepared according to the following constituency: one half by weight of beans being slightly roasted, one third being roasted to “medium dark”, and the last one-sixth is roasted to a “dark roast.” The three portions are mixed together and ground to get new Coffee III.

Chemical analysis showed that the new coffee III contains 2.7% of phenolic acids and 1.4% of chlorogenic acid.

During any of the roasting methods described above (or upon using variations thereof), the coffee may be flavored or supplemented with desired additives by conventional methods.

The invented procedures can also be used for producing decaffeinated or partly decaffeinated roasted coffee, in that a raw coffee is used as a basis and then the caffeine is partly or totally removed therefrom. Instant coffee can also be obtained by using newly-invented coffee beans as starting material.

In the preceding examples, all percentages are reported by weight. The chlorogenic acid contents given were obtained by high pressure liquid chromatography (HPLC) and UV photometric methods.

The preceding examples illustrate that a more healthful and more easily tolerated coffee product can be produced by a very simple variation of conventional coffee processing methods. In addition, an end product which is heavier per unit raw substrate input can be produced by the same method, and thereby provide an economic benefit to vendors. The present method yields a product which is in no way undesirable from an aesthetic standpoint. Thus, there is no reason not to, and every reason to, adopt the present coffee processing methods for the well-being of consumers.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A coffee beverage substrate produced by the steps of:
selecting a first measure of coffee beans which are green or roasted no more than leaves remaining at least approximately a 2% phenolic acid constituency of said first measure of coffee beans said first measure constituting not less than approximately 10% by weight of the intended end product weight;
selecting a second measure of coffee beans which are of a higher degree of roast than said first measure;
combining ground coffee produced by grinding said first and second measures to produced a blended coffee mixture, ground coffee produced from said first and second measures respectively contributing not less than 10%, nor more than 90% by weight of said blended coffee mixture.

2. The product of claim 1 wherein said second measure of coffee beans are roasted to a degree whereby said second measure of coffee beans exhibit no more than approximately a 1% phenolic acids constituency.
